(19) United States
(12) Patent Application Publication
(10) Pub. No.: US 2026/0061675 A1
(43) Pub. Date: Mar. 5, 2026

(54) APPARATUS AND METHOD FOR MANUFACTURING VEHICLE INTERIOR MATERIALS

(71) Applicant: SEOYON E-HWA CO., LTD., Anyang (KR)

(72) Inventor: Chiwon YOON, Anyang (KR)

(21) Appl. No.: 19/301,944

(22) Filed: Aug. 16, 2025

(30) Foreign Application Priority Data
Sep. 3, 2024 (KR) 10-2024-0119487
Sep. 3, 2024 (KR) 10-2024-0119488

(51) Int. Cl. B29C 45/14; B29C 45/26; B29C 45/56; B29L 31/30

(52) U.S. Cl. CPC B29C 45/14221; B29C 45/2602; B29C 45/561; B29C 2045/14188; B29L 2031/3005

(57) ABSTRACT

A vehicle interior material manufacturing device and a method for manufacturing a vehicle interior material using the same are disclosed. The device includes a first mold on which a Skin is supported, and a second mold configured to be opened and closed with respect to the first mold and on which a Base is supported. The first mold comprises a forming recess recessed on one surface of a first body, and a cutting section provided on both sides of the forming recess on the first body, the cutting section being configured to cut an end portion of the Base supported by the second mold during a mold closing process between the first and second molds.

### CROSS-REFERENCE TO RELATED APPLICATIONS

This application claims the priority to Korean Patent Application No. 10-2024-0119487 filed on September 03, 2024 and Korean Patent Application No. 10-2024-0119488 filed on September 3, 2024, in the Korean Intellectual Property Office, the disclosure of which is incorporated herein by reference in its entirety.

### BACKGROUND

### Field

The present disclosure relates to a device and a method for manufacturing vehicle interior materials, and more particularly, to a device and a method for manufacturing vehicle interior materials in which a Skin is integrated with a Base.

### Description of the Related Art

Vehicle interior materials are components used for the interior design of vehicles to enhance the aesthetics of the vehicle cabin, and examples include door trims, consoles, dashboards, and headliners.

Typically, vehicle interior materials are composed of a base and a skin. The base forms the shape of the interior material, and it is generally manufactured such that the skin covers the surface of the base in consideration of the appearance and tactile feel of the interior material.

Recently, due to increasing demands for premium vehicle interiors, interior materials are often manufactured in a form in which a rigid base is finished with a soft skin. In addition, as environmental issues have become prominent in modern society, the eco-friendliness and weight reduction of automobile parts have become essential in order to reduce carbon emissions. Accordingly, there is a growing trend of using natural fibers as an eco-friendly material for the base.

Furthermore, technologies have recently been developed in which a plastic resin is injection-molded on the rear surface of the base made of natural fibers to form an integrated structure. For example, plastic injection-molded parts such as ribs or brackets may be formed on the rear surface of the base to reinforce the insufficient strength caused by the fibrous material.

Meanwhile, in conventional methods of manufacturing vehicle interior materials, the processes of shaping the base into a predetermined form, cutting (trimming) the base, bonding the base and the skin, and injection-molding plastic resin on the rear surface of the base were all carried out as separate processes. Such conventional manufacturing processes for vehicle interior materials are very complex, and as the number of steps increases, productivity is reduced.

In addition, in conventional methods, in bonding the base and the skin, an adhesive was applied to the bonding surfaces of the skin and the base, and the components were then bonded by heat-pressing. Such conventional methods have the drawback of being environmentally unfriendly due to the use of harmful adhesives such as industrial glues.

Moreover, the above-described conventional methods have led to additional issues, including increased emission of volatile organic compounds (VOCs) and generation of unpleasant odors caused by the adhesive between the base and the skin, resulting in ongoing consumer dissatisfaction.

### SUMMARY

The present disclosure is proposed to address the problems of the conventional technologies described above. Specifically, the disclosure provides a vehicle interior material manufacturing device and method capable of integrally performing, as a single process in a single device, processes that were conventionally performed separately—namely, base press forming, base cutting, bonding between the base and the skin, and injection molding. This integration aims to reduce the manufacturing process steps and labor costs, thereby increasing the productivity of vehicle interior materials, and ultimately contributing to improved cost competitiveness of automobiles and enhanced fuel efficiency through vehicle weight reduction.

Another technical object of the present disclosure is to eliminate the use of conventional adhesives for bonding the base and the skin, and instead achieve bonding by utilizing the latent heat retained in the preheated base.

Still another technical object of the present disclosure is to enable the formation of various patterns on the surface of the skin within the same process, thereby enhancing the quality and appearance of vehicle interior materials.

The technical objects of the present disclosure are not limited to those mentioned above, and other technical objects not specifically stated will be clearly understood by those of ordinary skill in the art based on the following description.

According to one aspect of the present disclosure, a vehicle interior material manufacturing device may be provided, comprising: a first mold configured to support a Skin; and a second mold configured to support a Base and to be capable of opening and closing with the first mold, wherein the first mold comprises: a forming recess formed recessed on one surface of a first body; and a cutting section provided on both sides of the forming recess on the first body, the cutting section being configured to cut an end portion of the Base supported by the second mold during the mold closing process of the first mold and the second mold.

The second mold may comprise: a press section protruding from one side of a second body; a base support on which the Base is placed and supported and which is movable relative to the press section; and a spring member elastically supporting the base support on the second body.

The cutting section may comprise: a driving cylinder provided inside the first body and having an extendable rod; and a cutting knife configured to move vertically with respect to the surface of the first body by the actuation of the driving cylinder.

During the mold closing process, when the first mold and the second mold are moved toward each other, an end portion of the Base may be cut by the interaction between the base support and the cutting knife. When the first mold and the second mold are completely closed, the spring member may be compressed such that the base support is moved to both side portions of the press section.

Upon mold closing, a portion of the press section may be inserted into the forming recess, and a compression molding space for press-molding the Skin and the Base may be formed between the forming recess and the press section.

The Base may be supported on the base support in a preheated state at 180 to 250°C, and the Skin may be joined to the Base by the latent heat of the Base during the press molding process.

The second mold may further comprise: a cavity formed recessed in the surface of the press section; and a resin injection section configured to inject resin into the cavity.

When the Base supported on the base support is pressed against the surface of the press section due to the mold closing of the first and second molds, an injection molding space for injecting and molding resin may be formed between the Base and the cavity.

The second mold may further comprise: a lifting plate vertically movable within a space formed inside the second body; a pin member fixed to the lifting plate and extending through the second body and the press section; and a driving unit configured to move the lifting plate up and down.

After the press molding is performed, when the first mold and the second mold are opened, the pin member may be deployed from the press section by the upward movement of the lifting plate and may push the molded product, in which the Base and the Skin are bonded, toward the first mold.

A predetermined pattern may be formed on the inner surface of the forming recess, such that the pattern is transferred onto the molded article including the Skin and the Base during the press molding process.

According to another aspect of the present disclosure, a method for manufacturing vehicle interior materials using a vehicle interior material manufacturing device is provided, the device comprising a first mold and a second mold configured to be openable and closable, wherein a forming recess is recessed on one surface of the first mold, a press section is formed to protrude from one side of the second mold to correspond to the forming recess, and the press section is inserted into the forming recess to form a compression molding space. The method may comprise: inserting a Base and a Skin between the first mold and the second mold; cutting an end portion of the Base by a cutting section provided in the first mold during the process of the first mold and the second mold approaching each other; closing the first mold and the second mold; press molding the Base and the Skin by compressing them in the compression molding space; and opening the first mold and the second mold.

In the inserting step, the Skin may be placed and supported on the first mold side, and the Base may be placed and supported on the second mold side.

In the inserting step, the Base may be inserted in a preheated state at 180 to 250°C, and in the press molding step, the Skin may be bonded to the Base by the latent heat of the Base.

The second mold may further comprise a cavity formed in a groove shape on the mold surface and a resin injection section for injecting resin into the cavity. In the press molding step, while press molding of the Base and the Skin is performed, molten resin may be injected into the cavity to perform injection molding simultaneously.

In the press molding step, an injection member may be integrally formed on the rear surface of the Base by the injection molding.

The second mold may further comprise a pin member capable of being deployed from the mold surface. In the mold opening step, the pin member may be deployed from the mold surface of the second mold and push the molded article, in which the Base and the Skin are bonded, toward the first mold, thereby enabling the molded article to be demolded from the second mold.

The method for manufacturing vehicle interior materials according to another aspect of the present disclosure may further comprise a step of removing the molded article from the first mold.

According to the vehicle interior material manufacturing device and method of the present disclosure, base press forming, base cutting, bonding between the Base and the Skin, and injection molding can be collectively performed as a single process by a single device. Therefore, compared to conventional technologies, the manufacturing process can be simplified and labor reduced, significantly increasing the productivity of vehicle interior materials. Furthermore, it contributes to improving the cost competitiveness of automobiles and enhancing fuel efficiency through vehicle weight reduction.

In addition, the present disclosure enables the omission of adhesive use during bonding between the Base and the Skin, which makes the process environmentally friendly and helps resolve issues related to VOC emissions and odor generation caused by the use of adhesives.

The advantages of the present disclosure are not limited to the effects described above, and other effects not explicitly mentioned will be clearly understood from the following description by those of ordinary skill in the art.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating the vehicle interior material manufacturing device according to the present disclosure.

FIGS. 1 to 6 are diagrams sequentially illustrating operations for manufacturing a vehicle interior material using the vehicle interior material manufacturing device according to the present disclosure.

FIG. 1 illustrates a step of inserting a Base and a Skin into the mold.

FIG. 2 illustrates a step in which the movable mold advances.

FIG. 3 illustrates a step in which the Base is cut during advancement of the movable mold.

FIG. 4 illustrates a step in which the mold is fully closed, the Base and the Skin are compressed, and resin is injected into the rear surface of the Base to perform injection molding.

FIG. 5 illustrates a step in which the mold is opened.

FIG. 6 illustrates a step of removing the molded article from the mold.

FIG. 7 is a diagram illustrating an example of a transferred pattern design formed by a pattern processed on the surface of the mold.

### DETAILED DESCRIPTION OF THE EMBODIMENT

Hereinafter, the present embodiment will be described in detail with reference to the accompanying drawings. The following embodiment is provided to sufficiently convey the spirit of the present disclosure to those skilled in the art to which the disclosure pertains. The present disclosure is not limited to the embodiment described herein and may be embodied in other forms. Parts unrelated to the explanation may be omitted from the drawings for clarity, and the sizes of components may be exaggerated to aid understanding.

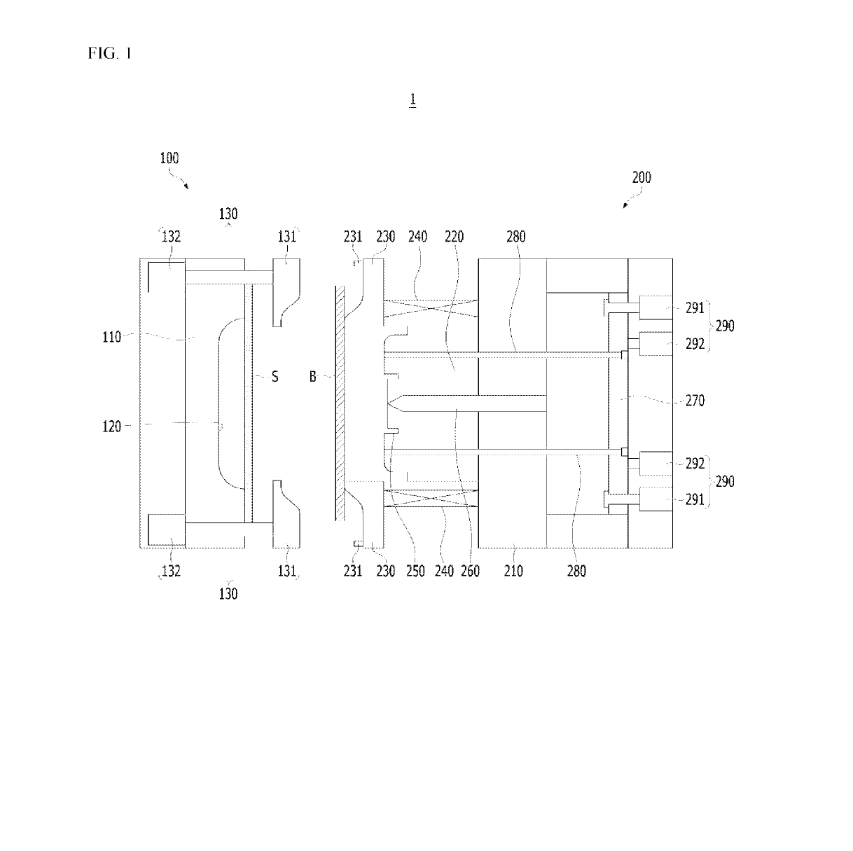

FIG. 1 is a diagram illustrating the vehicle interior material manufacturing device according to the present disclosure. Referring to FIG. 1, the vehicle interior material manufacturing device 1 according to the present disclosure may include a first mold 100 and a second mold 200, which are configured to be openable and closable with respect to each other.

One of the first mold 100 and the second mold 200 may be a fixed mold, and the other may be a movable mold. In the present embodiment, the first mold 100 may be configured as a movable mold capable of advancing or retracting toward the second mold 200. However, the present disclosure is not limited thereto, and it is also possible for the second mold 200 to be configured as the movable mold while the first mold 100 is fixed, or for both the first mold 100 and the second mold 200 to be movable molds.

In the present embodiment, a Skin S may be placed and supported on the side of the first mold 100, and a Base B may be placed and supported on the side of the second mold 200.

The Skin S supported by the first mold 100 may be a fabric or film made of materials such as fibers, synthetic leather, natural leather, or synthetic resin.

The Base B supported by the second mold 200 serves to form the shape of the vehicle interior material manufactured according to the present disclosure and may be a composite material made of natural fibers, synthetic fibers, or a mixture thereof. For example, the Base B may be a composite material in which a reinforcing layer or a coating layer, such as a glass fiber layer or nonwoven fabric, is formed on the top and/or bottom surface of a core layer made by mixing natural fibers and synthetic fibers.

The first mold 100 and the second mold 200 serve to press-mold (compression mold) the Base B inserted therebetween by mold closing (clamping). In this process, the Skin S inserted between the first mold 100 and the second mold 200 is also pressed, and the Base B, inserted in a preheated state as described later, may be bonded to the Skin S by means of the latent heat retained in the Base B.

In the present embodiment, the first mold 100 may include a first body 110, a forming recess 120 formed recessed on one surface of the first body 110, and cutting sections 130 provided at both ends of the first body 110.

The forming recess 120 may be formed in a concave shape recessed on the surface of the first body 110 facing the second mold 200. The forming recess 120 may be shaped to correspond to a press section 220 described later, and its shape may vary depending on the shape of the molded article to be formed. In addition, the inner surface of the forming recess 120 may be formed with a molding surface having various shapes corresponding to the shape to be imparted to the molded article.

Conventionally, a pattern was transferred after molding the Base, followed by a post-processing stitching step to form the pattern. However, such conventional methods have the disadvantages of being complex in process and limited in design flexibility.

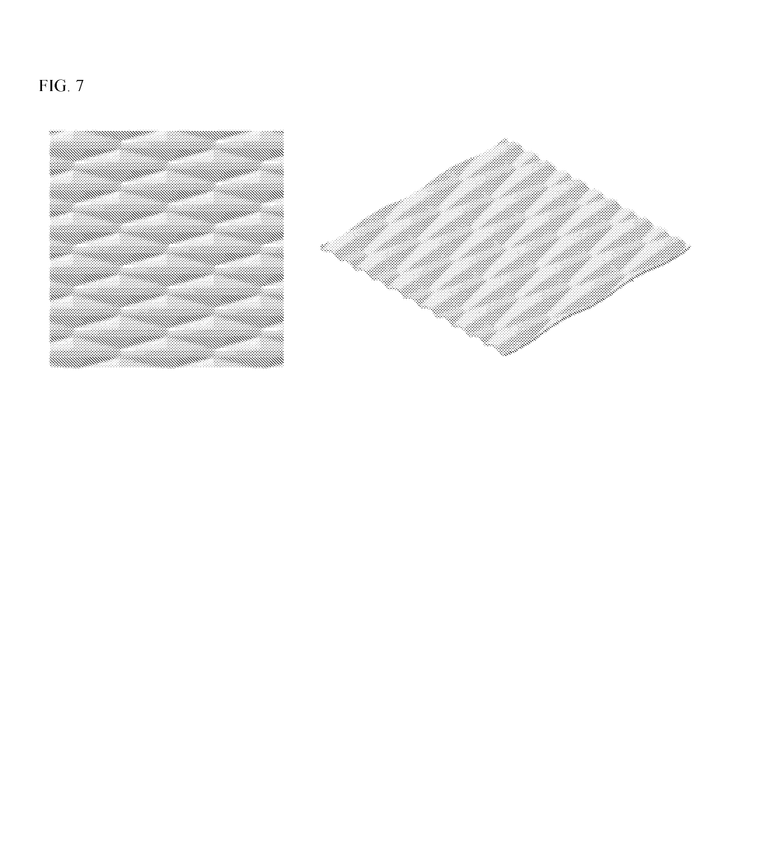

To address these issues, the present disclosure provides a configuration in which a desired pattern is machined on the molding surface of the forming recess 120, and during press molding of the Base B and the Skin S between the forming recess 120 and the press section 220, the molded article including the Base B and the Skin S is shaped to match the mold shape, thereby eliminating the stitching step. FIG. 7 is a diagram illustrating an example of a pattern design transferred by a pattern processed on the surface of the mold.

That is, in the present disclosure, a pattern is machined on the surface of the mold so that the pattern is directly transferred onto the molded article during the press molding process. According to the present disclosure, the conventional stitching process can be eliminated, thereby increasing productivity and enhancing design flexibility, such as achieving volume maximization and edge detailing.

The forming recess 120, together with the press section 220 described later, substantially compresses the Skin S and the Base B inserted between the molds 100 and 200. Specifically, the press section 220 of the second mold 200 is inserted into the forming recess 120 of the first mold 100, and the Base B inserted therebetween is molded into the desired shape by the compressive force. Simultaneously, the Skin S may be naturally bonded to one surface of the Base B by the latent heat contained in the Base B.

A key feature of the present disclosure lies in the bonding of the Base B and the Skin S using the latent heat of the Base B without the use of adhesives. To achieve this, the Base B needs to be cut in advance before the press molding process, particularly at the wrapping margin, which requires the device to be configured to perform pre-cutting of the preheated Base B.

The vehicle interior material manufacturing device 1 according to the present disclosure is configured to implement such pre-cutting of the preheated Base B by means of a cutting section 130 provided in the first mold 100.

The cutting section 130 is configured to cut unnecessary end portions of the Base B supported on the second mold 200 during the mold closing process of the first mold 100 and the second mold 200, and may include a cutting knife 131 and a driving cylinder 132.

The cutting knife 131 is configured to cut unnecessary end portions of the Base B through interaction with the base support 230 provided on the side of the second mold 200 when the first mold 100 and the second mold 200 are closed.

More specifically, during mold closing of the first mold 100 and the second mold 200, the cutting knives 131 provided just outside the forming recess 120 on both sides engage with the base support 230 supporting the Base B, thereby cutting the edge portions of the Base B. Subsequently, the press section 220 of the second mold 200 is inserted into the forming recess 120 of the first mold 100, and only the necessary portion of the Base B, with the edge removed, is pushed into the forming recess 120.

The cutting knife 131 may be formed with a sharp cutting edge at its end to facilitate easy cutting of unnecessary portions of the Base B.

In addition, the cutting knife 131 may be configured to perform vertical motion relative to the surface of the first body 110. Here, vertical motion refers to a reciprocating motion in the direction of force applied by the driving cylinder 132, which, as seen in the drawings, corresponds to left-right movement.

The driving cylinder 132 is a component for moving the cutting knife 131 up and down. As the rod of the driving cylinder 132 extends or retracts, the cutting knife 131 moves away from or toward the surface of the first body 110. The driving cylinder 132 may be implemented as a device such as a gas spring or a hydraulic cylinder.

In the present embodiment, the second mold 200 may include: a second body 210; a press section 220 protruding from one side of the second body 210; a base support 230 on which the Base B is placed and supported and which is configured to be movable relative to the press section 220; a spring member 240 elastically supporting the base support 230 on the second body 210; a cavity 250 formed recessed in the surface of the press section 220; and a resin injection section 260 configured to inject molten plastic resin into the cavity 250.

The press section 220 may be generally formed to protrude from the central portion of the second mold 200. When the first mold 100 and the second mold 200 are closed, a portion of the press section 220 is inserted into the forming recess 120 formed at the center of the first mold 100, thereby forming a compression molding space between the forming recess 120 and the press section 220.

The Base B inserted into the compression molding space may be press-molded into a predetermined shape by the pressing force generated as the forming recess 120 and the press section 220 approach each other. In addition, the Skin S inserted into the compression molding space is brought into close contact with the Base B by the same pressing force, and bonding between the Base B and the Skin S may be achieved by the latent heat retained in the Base B.

As described above, the shapes of the forming recess 120 formed in the first mold 100 and the press section 220 formed in the second mold 200 may vary depending on the shape of the molded article to be formed.

The base support 230 serves as a support plate for preventing wrinkles or ruptures in the Base B. It not only provides a structure on which the Base B is placed and supported, but also assists in cutting unnecessary end portions of the Base B through interaction with the above-described cutting knife 131. To this end, the base support 230 is provided at a position corresponding to the cutting knife 131 and has a shape that engages with the cutting knife 131.

The Base B supported on the base support 230 is preferably inserted between the first mold 100 and the second mold 200 in a preheated state. In the present embodiment, the Base B may be inserted between the molds 100 and 200 while preheated to approximately 180 to 250°C. As repeatedly emphasized, this is to enable bonding between the Base B and the Skin S via the latent heat of the Base B when the two molds 100 and 200 are closed and the Base B and Skin S inserted therebetween are compressed. Due to the latent heat of the Base B preheated to approximately 180 to 250°C, the surface of the fabric or film forming the Skin S is slightly melted and can be easily bonded to the Base B.

Meanwhile, a protrusion 231 may be formed at the edge of the surface of the base support 230 that faces the cutting knife 131. The protrusion 231 is configured to form a predetermined gap between the cutting knife 131 and the base support 230, so that the Base B can be smoothly drawn in when the first mold 100 and the second mold 200 are closed.

The spring member 240 serves to elastically support the base support 230 on the second body 210, providing elastic force. It is compressed as the first mold 100 and the second mold 200 approach each other, and it returns to its original position by releasing the pressure when the molds move apart.

The cavity 250 may be formed as a groove on the surface of the press section 220. When the first mold 100 and the second mold 200 approach each other and the Base B supported on the base support 230 is pressed against the surface of the press section 220, a space is formed between the Base B and the cavity 250, serving as an injection molding space into which molten resin is injected and molded.

The cavity 250 may be formed in various groove shapes depending on the shape of the injection member required, and molten resin may be injected into the cavity 250 through the resin injection section 260.

The molten resin injected into the cavity 250 is integrally injection-molded onto the rear surface of the Base B. The injection-molded component formed on the rear surface of the Base B (hereinafter referred to as injection member I) may be, for example, a rib or a bracket, and the cavity 250 may be shaped to correspond to the intended shape of the injection member I.

In the present embodiment, the second mold 200 may further include a lifting plate 270 vertically movable within a space formed inside the second body 210; a pair of pin members 280 fixed to the lifting plate 270 and extending through the second body 210 and the press section 220; and a driving unit 290 configured to move the lifting plate 270 up and down.

The lifting plate 270 is capable of vertical movement within the internal space of the second body 210. Here, the vertical movement refers to a reciprocating motion in the direction in which force is applied by the driving unit 290, which corresponds to left-right movement as shown in the drawings.

The pin members 280 are fixed to the lifting plate 270 and are installed to extend through the second body 210 and the press section 220. The pin members 280 may slide along the through-holes of the second body 210 and the press section 220 by the vertical movement of the lifting plate 270.

In the present embodiment, the pin members 280 may form part of the press section 220. When the lifting plate 270 is fully retracted (i.e., moved to the right in the drawings), the tips of the pin members 280 form part of the molding surface of the press section 220. When the lifting plate 270 advances (i.e., moves to the left in the drawings), the pin members 280 may be deployed forward (to the left in the drawings) from the press section 220.

In the present embodiment, the lifting plate 270, the pin members 280, and the driving unit 290 are configured to ensure that the molded article remains adhered to the first mold 100, rather than sticking to the second mold 200, when the molds 100 and 200 are opened after the press molding and injection molding are completed. Here, the molded article refers to a product in which the Base B, the Skin S, and the injection member I are integrally bonded upon completion of press molding and injection molding.

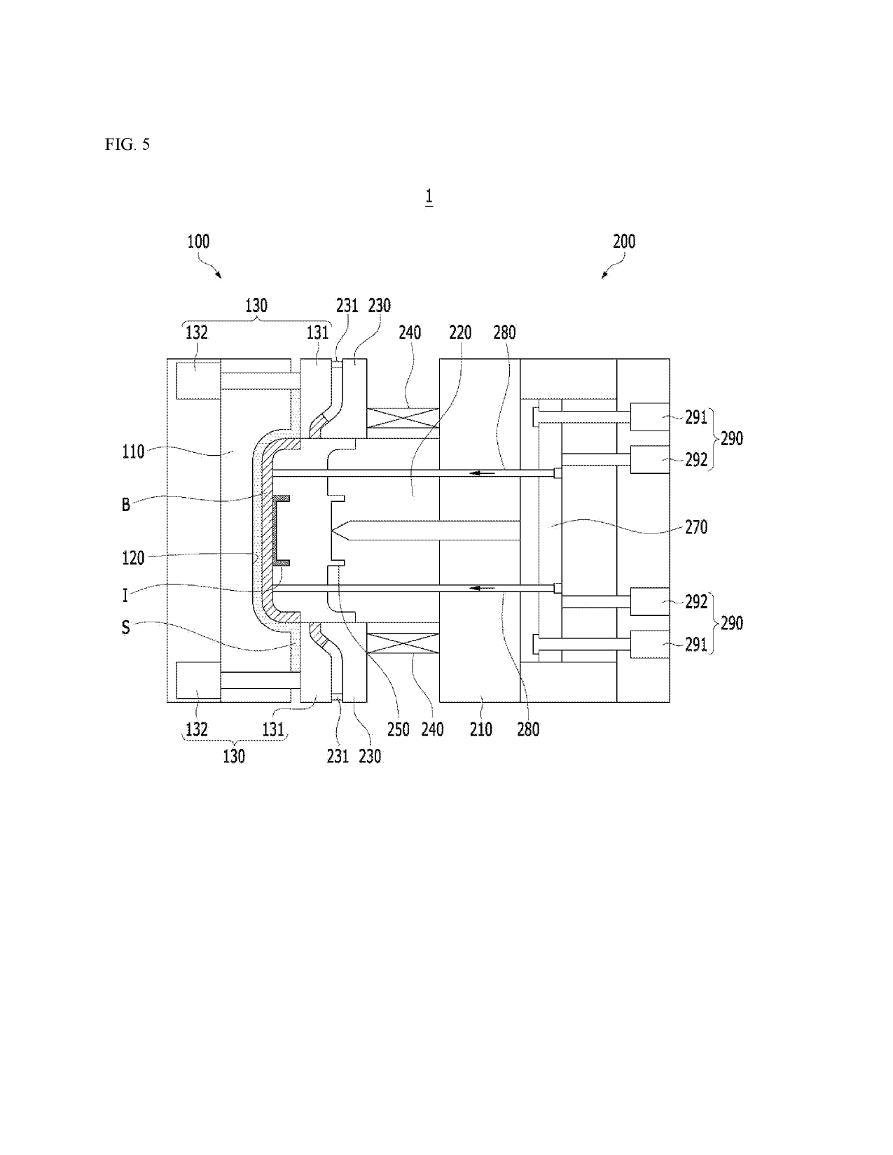

The pin members 280 remain retracted within the press section 220 until the press molding and injection molding are completed (see FIGS. 1 to 4). Once the molding processes are finished and the first mold 100 and the second mold 200 are separated for mold opening, the movable first mold 100 is moved away from the second mold 200. At the same time, the driving unit 290 is actuated to advance the lifting plate 270 and deploy the pin members 280. The pin members 280, deployed from the second mold 200, push against the rear surface of the Base B, and this pushing force allows the molded article to remain adhered to the first mold 100 and to be released from the second mold 200 (see FIG. 5).

The driving unit 290, which serves as a drive source for raising and lowering the lifting plate 270, may be implemented as a device combining a hydraulic cylinder 291 with an extendable rod and a gas spring 292 having elasticity.

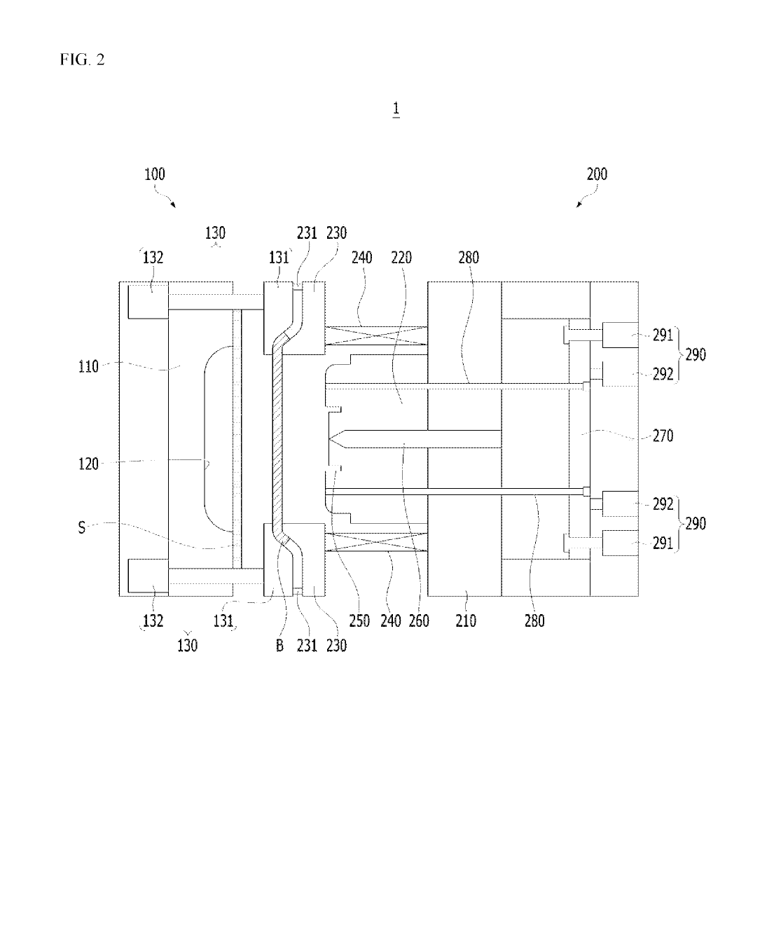

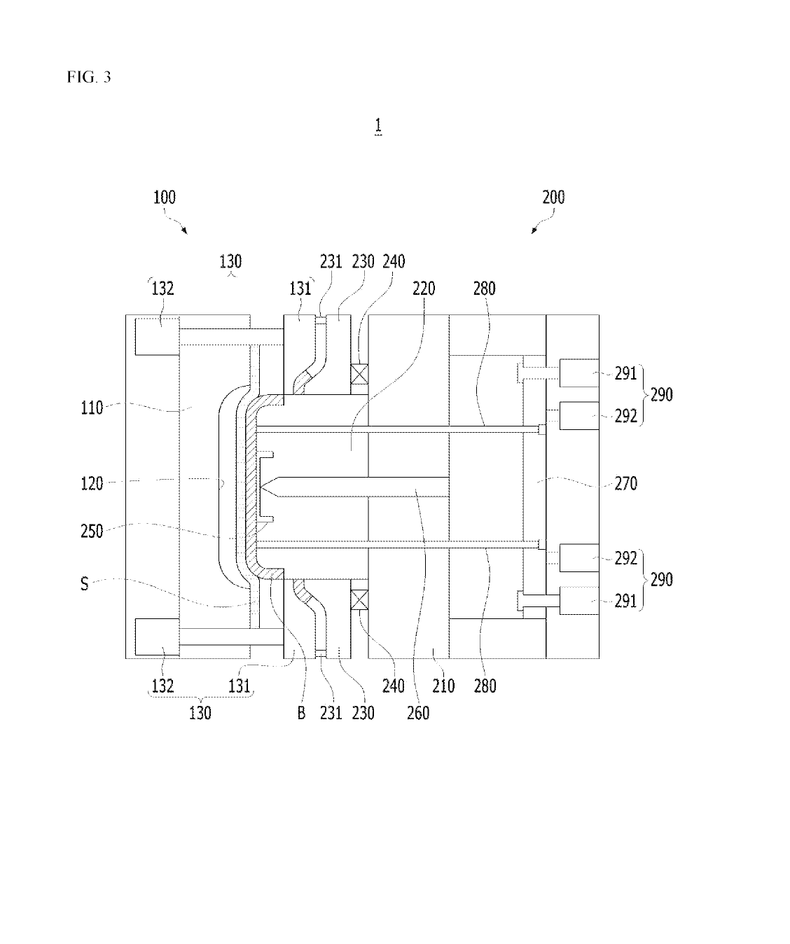

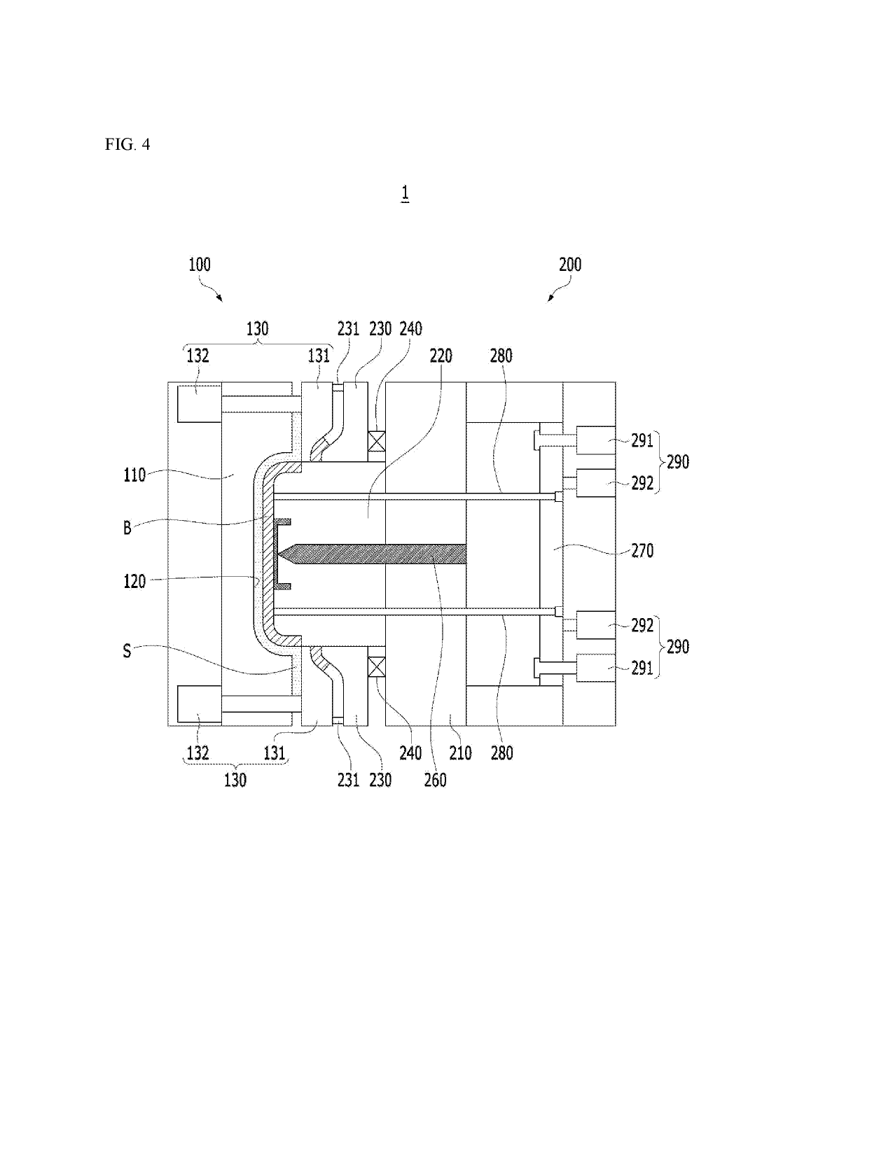

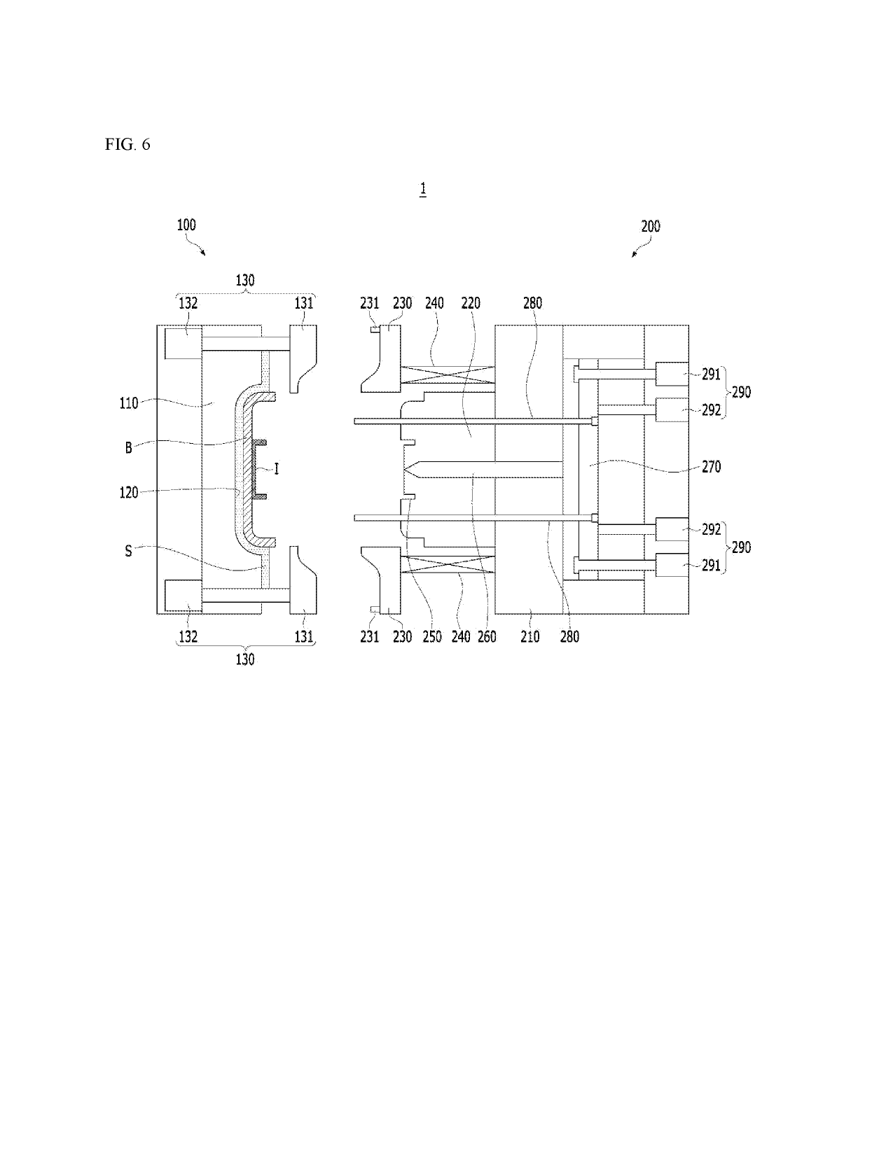

FIGS. 1 to 6 sequentially illustrate the operations for manufacturing a vehicle interior material using the vehicle interior material manufacturing device according to the present disclosure. FIG. 1 illustrates a step of inserting the Base and the Skin into the mold; FIG. 2 illustrates a step in which the movable mold advances; FIG. 3 illustrates a step in which the Base is cut during the advancement of the movable mold; FIG. 4 illustrates a step in which the mold is closed, the Base and the Skin are compressed, and resin is injected into the rear surface of the Base to perform injection molding; FIG. 5 illustrates a step in which the mold is opened; and FIG. 6 illustrates a step of removing the molded article from the mold.

Hereinafter, with reference to FIGS. 1 to 6, the method for manufacturing a vehicle interior material using the vehicle interior material manufacturing device 1 according to the present disclosure will be described sequentially.

(1) Step of inserting the Base and the Skin into the mold

First, referring to FIG. 1, the Base B and the Skin S are inserted between the first mold 100 and the second mold 200. At this time, the Skin S is placed and supported on the surface of the first body 110 of the first mold 100, and the Base B is placed and supported in a preheated state (180 to 250°C) on the base support 230 of the second mold 200. The Skin S and the Base B may be placed and supported on the respective molds 100 and 200 by mechanical or electronic means.

(2) Step of advancing the movable mold

Referring to FIG. 2, in order to close the first mold 100 and the second mold 200, the movable mold, i.e., the first mold 100, is moved toward the second mold 200. At this time, the cutting knife 131 of the cutting section 130 may remain in a slightly separated state from the surface of the first body 110 of the first mold 100 by the driving cylinder 132.

As the first mold 100 and the second mold 200 approach each other, the cutting knife 131 provided on the first mold 100 and the base support 230 provided on the second mold 200 meet first.

(3) Step of cutting the Base during the advancement of the movable mold

Referring to FIG. 3, the cutting knife 131 and the base support 230 are engaged with the Base B interposed therebetween. When the first mold 100 is further pushed to the right, the pushing force cuts the unnecessary edge portion of the Base B supported on the base support 230.

In addition, the spring member 240, which elastically supports the base support 230, is compressed so that the base support 230 moves to both side portions of the press section 220, and the press section 220 of the second mold 200 reaches the state just before it is inserted into the forming recess 120 of the first mold 100.

Here, the force applied by the driving cylinder 132 must act greater than the elastic force of the spring member 240 that elastically supports the base support 230.

(4) Step of completely closing the mold, compressing the Base and the Skin, and simultaneously injecting resin to the rear surface of the Base for injection molding

Referring to FIG. 4, the first mold 100 and the second mold 200 are completely closed, and the Base B inserted between the forming recess 120 of the first mold 100 and the press section 220 of the second mold 200 is pressed and compression-molded. In this process, the Skin S is bonded to the Base B by the pressing force applied by the molds 100 and 200 and the latent heat retained in the Base B.

As such, the disclosure achieves the bonding between the Base B and the Skin S by utilizing the latent heat of the Base B without using an adhesive as in the conventional method. The Base B and the Skin S can be integrally molded and strongly bonded to each other in the compression molding space formed between the first mold 100 and the second mold 200.

To perform such compression molding, when the first mold 100 and the second mold 200 are closed, the rod of the driving cylinder 132 of the cutting section 130 is contracted, so that the cutting knife 131 moves toward the surface of the first body 110. Here, the cutting knife 131 holds the edge portion of the Skin S that is not inserted into the forming recess 120, thereby ensuring the compression molding and the injection molding process described below proceed stably.

Meanwhile, in this step, injection molding may also be performed by injecting molten resin into the cavity 250 formed on the second mold 200 side simultaneously with the compression molding.

As the first mold 100 and the second mold 200 are closed, an injection molding space is formed between the Base B in close contact with the surface of the press section 220 and the cavity 250 formed in a groove shape. The molten resin injected into the space is solidified after a certain time and injection-molded into a molded article having the same shape as the injection molding space.

(5) Step of opening the mold

Referring to FIG. 5, after the above steps are completed, the compression molding and injection molding are finished, resulting in a molded article in which the Base B, the Skin S, and the injection member I are integrally bonded. To eject the molded article, the first mold 100 and the second mold 200 are spaced apart to open the mold.

At this time, while the movable mold (the first mold 100) is moved away from the second mold 200, the driving unit 290 provided in the second mold 200 is actuated to advance the lifting plate 270 and deploy the pin members 280. The molded article is then pushed by the force of the pin members 280 deployed from the second mold 200, and maintained in a state where it remains adhered to the first mold 100, thereby being released from the second mold 200.

The molded article in which the Base B, the Skin S, and the injection member I are integrally bonded is more difficult to detach from the second mold 200, which is in contact with the Base B having the injection member, than from the first mold 100, which is in contact with the Skin S. Furthermore, due to the presence of the cutting knife 131, if the molded article adheres to the second mold 200 while the edge of the Skin S is supported by the first mold 100, there is a risk that the bonding strength between the Base B and the Skin S formed during the compression molding process may be weakened.

In consideration of such problems, the disclosure provides a structure that allows the molded article to remain adhered to the first mold 100 and be released from the second mold 200 during the mold opening process after the molding is completed.

(6) Step of removing the molded article from the mold

Referring to FIG. 6, the rod of the driving cylinder 132 of the cutting section 130 is extended again to release the end of the Skin S that was fixed by the cutting knife 131, and the molded article, in which the Base B, the Skin S, and the injection member I are integrally bonded, can be removed from the first mold 100.

Meanwhile, the edge portion of the Skin S that is not joined to the Base B in the molded article (i.e., the portion not introduced into the forming recess 120) serves as a wrapping portion. By performing an additional wrapping operation using the wrapping portion of the Skin S to wrap around the Base B, the manufacturing of the vehicle interior material can be completed. This wrapping operation may be performed while the molded article is still held in shape before being removed from the first mold 100, or it may be performed separately after the molded article is removed.

In the prior art, the molded article formed by compression molding the base and the skin inside a press mold was typically removed from the mold and then trimmed along its outer edge to complete the vehicle interior material. However, in the present disclosure, the device is configured to cut unnecessary edge portions of the Base B during the mold closing process, and after the molded article is removed from the mold, only a simple wrapping step using the wrapping portion of the Skin S is needed to wrap the Base B. Therefore, the manufacturing process for vehicle interior materials can be greatly simplified.

As described above, the vehicle interior material manufacturing device 1 according to the disclosure is configured such that the unnecessary edge of the Base B is automatically cut during the process of closing the molds 100 and 200 to compress-mold the Skin S and the Base B. In addition, the device is designed so that compression molding of the Skin S and the Base B inserted between the molds 100 and 200 is performed while simultaneously injection molding an injection member integrally on the rear surface of the Base B.

The vehicle interior material manufacturing device 1 and the method of manufacturing a vehicle interior material using the same according to the present disclosure can be applied to various automotive interior components configured to include the Base B, the Skin S, and the injection member I formed on the rear surface of the Base B.

What is claimed is:

1. A vehicle interior material manufacturing device comprising:
a first mold on which a Skin is supported; and
a second mold configured to be opened and closed with respect to the first mold and on which a Base is supported,
wherein the first mold comprises:
a forming recess recessed on one surface of a first body; and
a cutting section provided on both sides of the forming recess on the first body and configured to cut an end portion of the Base supported by the second mold during a closing process of the first and second molds.

2. The vehicle interior material manufacturing device of claim 1,
wherein the second mold comprises:
a press section protruding from one side of a second body;
a base support on which the Base is seated and supported, and which is movable relative to the press section; and
a spring member elastically supporting the base support on the second body.

3. The vehicle interior material manufacturing device of claim 1,
wherein the cutting section comprises a cutting knife configured to move up and down from a surface of the first body by driving of a driving cylinder.

4. The vehicle interior material manufacturing device of claim 3,
wherein when the first mold and the second mold are brought closer for mold closing, the base support and the cutting knife engage to cut an end portion of the Base,
and when the first and second molds are fully closed, the spring member is compressed to move the base support to side portions of the press section.

5. The vehicle interior material manufacturing device of claim 2,
wherein a portion of the press section is inserted into the forming recess during mold closing of the first and second molds, and a compression molding space for press molding of the Skin and the Base is formed between the forming recess and the press section.

6. The vehicle interior material manufacturing device of claim 5,
wherein the Base is supported on the base support in a preheated state at 180 to 250℃, and the Skin is bonded to the Base by latent heat of the Base during the press molding process.

7. The vehicle interior material manufacturing device of claim 5,
wherein the second mold further comprises:
a cavity recessed on a surface of the press section; and
a resin injection section for injecting resin into the cavity.

8. The vehicle interior material manufacturing device of claim 7,
wherein, when the Base supported on the base support is brought into close contact with the surface of the press section by mold closing of the first and second molds, an injection molding space for resin injection molding is formed between the Base and the cavity.

9. The vehicle interior material manufacturing device of claim 2,
wherein the second mold further comprises:
a lifting plate provided to be vertically movable within a space formed inside the second body;
pin members fixed on the lifting plate and extending through the second body and the press section; and
a driving unit for vertically moving the lifting plate.

10. The vehicle interior material manufacturing device of claim 9,
wherein when the first and second molds are opened after the press molding, the pin members are deployed from the press section by elevation of the lifting plate to push a molded article, in which the Base and the Skin are bonded, toward the first mold.

11. The vehicle interior material manufacturing device of claim 5,
wherein a predetermined pattern is processed on an inner surface of the forming recess, and the pattern is transferred onto a molded product including the Skin and the Base during the press molding process.

12. A method of manufacturing a vehicle interior material using a vehicle interior material manufacturing device comprising first and second molds configured to be opened and closed, wherein a forming recess is recessed on one surface of the first mold, a press section is formed to protrude on one side of the second mold corresponding to the forming recess, and the press section is inserted into the forming recess to form a compression molding space, the method comprising:
inserting a Base and a Skin between the first mold and the second mold;
cutting an end portion of the Base by a cutting section provided in the first mold during an approaching process of the first and second molds;
closing the first and second molds;
press molding the Base and the Skin by compression in the compression molding space; and
opening the first and second molds.

13. The method of claim 12,
wherein the Skin is seated and supported on the first mold, and the Base is seated and supported on the second mold in the inserting step.

14. The method of claim 13,
wherein the Base is inserted in a preheated state at 180 to 250℃ in the inserting step,
and the Skin is bonded to the Base by latent heat of the Base during the press molding step.

15. The method of claim 14,
wherein the second mold further comprises a cavity formed in a groove shape on a mold surface and a resin injection section for injecting resin into the cavity,
and in the press molding step, while the Base and the Skin are press molded, molten resin is injected into the cavity for injection molding.

16. The method of claim 15,
wherein in the press molding step, the molten resin is integrally molded on a rear surface of the Base by the injection molding.

17. The method of claim 14,
wherein the second mold further comprises pin members configured to be deployed from a mold surface,
and in the opening step, the pin members are deployed from the mold surface of the second mold to push a molded article, in which the Base and the Skin are bonded, toward the first mold for demolding from the second mold.

18. The method of claim 17,
further comprising a step of extracting the molded article from the first mold.
